(19) United States
(12) Patent Application Publication
(10) Pub. No.: US 2025/0303461 A1
(43) Pub. Date: Oct. 2, 2025

(54) FLARING DEVICE AND FLARING TOOL

(71) Applicant: MAKITA CORPORATION, Anjo-shi (JP)

(72) Inventors: Yuya INOUE, Anjo-shi (JP); Toshihito Yabunaka, Anjo-shi (JP); Hiroki Ikuta, Anjo-shi (JP)

(73) Assignee: MAKITA CORPORATION, Anjo-shi (JP)

(21) Appl. No.: 19/072,701

(22) Filed: Mar. 6, 2025

(30) Foreign Application Priority Data
Mar. 28, 2024 (JP) 2024-054905

(51) Int. Cl. B21D 41/02

(52) U.S. Cl. CPC B21D 41/023

(57) ABSTRACT

A clutch mechanism of a flaring device is includes a fixed clutch member, a movable clutch member, and a pressing spring. A first engagement portion of the main shaft and a second engagement portion of the movable clutch member form a feed screw mechanism. The movable clutch member is movable in a front-rear direction relative to fixed clutch member between (i) a first position where the movable clutch member is pressed against a cam surface by an urging force of the pressing spring and is held to be substantially non-rotatable relative to the fixed clutch member, and (ii) a second position where the movable clutch member is rotatable relative to the fixed clutch member. At the second position, the movable clutch member is configured to (i) be freely rotatable, relative to the fixed clutch member, in a first direction, and (ii) be restricted from rotating in a second direction.

### CROSS-REFERENCE TO RELATED APPLICATION

This application claims priority to Japanese patent application No. 2024-054905 filed on Mar. 28, 2024, the contents of which are fully incorporated herein by reference.

### TECHNICAL FIELD

The present disclosure relates to a flaring device and a flaring tool provided with the flaring device.

### BACKGROUND

A known flaring device is configured to form a flare (a portion expanded into a cone shape) at an end portion of a pipe (tube). A general flaring device is provided with a main shaft that is capable of moving in a front-rear direction along a drive axis while rotating around the drive axis, and a cone that is eccentrically supported at a front end portion of the main shaft to be rotatable around an axis that is different from the drive axis. The flare is formed by the cone gradually pressing and widening the end portion of the pipe as the main shaft moves forward from an initial position while rotating. After the flare is formed, the main shaft moves rearward to the initial position.

For example, a flaring device disclosed in Patent Literature 1 is provided with a clutch flange that is housed inside a holder and engages with the main shaft. When a clutch pin bearing of the clutch flange is latched to clutch pins by being urged rearward by an urging spring, the rotation of the clutch flange relative to the holder is obstructed. Thus, the main shaft moves in the front-rear direction relative to the holder and the clutch flange due to action of a feed screw.

### SUMMARY

In the above-described flaring tool, an opening is formed in a side portion of the hollow cylindrical shaped holder, and the clutch pin bearing of the clutch flange, the clutch pins, and the urging spring are arranged inside the opening. In this type of configuration, it is possible that a lubricant disposed inside the holder (grease, for example) may leak from the opening. Further, since it is necessary to cause the clutch pins and the urging spring to be held in the holder, there is a disadvantage in terms of increasing a number of components and making a structure more complex.

A non-limiting object of the present disclosure is to provide improvement relating to a clutch mechanism in a flaring device.

One non-limiting aspect of the present disclosure herein provides a flaring device that includes a housing, a main shaft, a cone, and a clutch mechanism. The main shaft is rotatable around a first axis defining a front-rear direction of the flaring device, and is housed in the housing to be movable in the front-rear direction along the first axis. The main shaft includes a first engagement portion. The cone is (i) eccentrically supported at a front end portion of the main shaft to be rotatable around a second axis that is different from the first axis, and (ii) is configured to form a flare in an end portion of a pipe. The clutch mechanism is housed in the housing. The cone is rotating around the second axis. The cone is not rotating eccentrically around the second axis. In other words, the second axis is offset from the first axis, and the cone is rotating around the second axis.

The clutch mechanism includes a fixed clutch member, a movable clutch member, and a pressing spring. The fixed clutch member includes a cam surface. The fixed clutch member is disposed around the main shaft to be substantially unmovable relative to the housing. The movable clutch member is disposed around the main shaft to the rear of the fixed clutch member. The movable clutch member includes a second engagement portion that is configured to directly or indirectly engage with the first engagement portion of the main shaft. The pressing spring is configured to urge the movable clutch member in a forward direction.

The first engagement portion of the main shaft and the second engagement portion of the movable clutch member form a feed screw mechanism that is configured to move the main shaft and the movable clutch member relative to each other in the front-rear direction. Note that the feed screw mechanism may include a first engagement portion formed as a male screw portion, and a second engagement portion formed as a female screw portion that threadably engages (directly engages) with the male screw portion. Alternatively, the feed screw mechanism may be a ball screw mechanism formed such that a first engagement portion including a first spiral groove and a second engagement portion including a second spiral groove are engaged with each other via a plurality of balls rollably disposed in a track defined by the first spiral groove and the second spiral groove.

The movable clutch member is movable in the front-rear direction relative to the fixed clutch member, between (i) a first position where the movable clutch member is pressed against the cam surface by an urging force of the pressing spring and is held to be substantially non-rotatable relative to the fixed clutch member, and (ii) a second position where the movable clutch member separates from the cam surface and is rotatable relative to the fixed clutch member. At the second position, the movable clutch member is configured to (i) be freely rotatable, relative to the fixed clutch member, in a first direction that is a rotation direction when the main shaft is moved in the forward direction, and (ii) be restricted from rotating in a second direction that is a rotation direction when the main shaft is moved in a rearward direction. Note that “be restricted” in the present aspect is not limited to covering a case of completely prohibiting the rotation of the movable clutch member in the second direction, and also covers a case in which a certain amount of rotation is allowed, and any further rotation is prohibited.

The flaring device according to the present aspect can move the main shaft in the front-rear direction using the feed screw mechanism, and can form the flare in the end portion of the pipe using the cone supported at the front end portion of the main shaft. Specifically, when the movable clutch member is at the first position, if the main shaft is rotated in the first direction while being movable in the forward direction, the main shaft is moved forward by the feed screw mechanism. Thereafter, when the flare is formed in the end portion of the pipe by the cone, and the forward movement of the main shaft is obstructed, due to the action of the feed screw mechanism, the movable clutch member moves from the first position to the second position (in other words, the clutch mechanism is actuated). If the rotation of the main shaft in the first direction is continued while the movable clutch member is at the second position, the movable clutch member rotates integrally with the main shaft in the first direction while receiving the urging force (biasing force) of the pressing spring. Thus, it is possible to improve the finish of the flare formed in the end portion of the pipe.

Subsequently, when the main shaft is rotated in the second direction, a reaction force from the pipe and the urging force of the pressing spring cancel each other out and the movable clutch member can rotate integrally with the main shaft at the second position. If the movable clutch member and the main shaft continue to rotate integrally in this state, the feed screw mechanism cannot move the main shaft rearward. In contrast to this, according to the clutch mechanism according to the present aspect, since the movable clutch member is restricted from rotating in the second direction, the feed screw mechanism can move the main shaft rearward relative to the movable clutch mechanism, and it is possible to reduce the reaction force from the pipe. As a result, the movable clutch member can return to the first position due to the urging force of the pressing spring.

In the flaring device according to the present aspect, the fixed clutch member that includes the cam surface, and the movable clutch member that is held by being pressed against the cam surface by the pressing spring are employed as the clutch mechanism. Thus, compared to a known clutch mechanism in which clutch pins and an urging spring that urges the clutch pins toward a clutch flange that is on a movable side are held at an opening in a side portion of a holder, it is possible to simplify a structure of the clutch mechanism. Further, since there is no need to provide an opening in a side portion of the housing that houses the clutch mechanism, it is possible to reduce the possibility of a leakage of lubricant. As a supplementary explanation, the cone is rotating around a second axis. The second axis is offset from the first axis. The second axis intersects the first axis.

Another non-limiting aspect of the present disclosure also provides an electric flaring tool that includes a tool housing, the flaring device according to the aspect described above, and a motor. The flaring device is housed in the tool housing. The motor is housed in the tool housing. The motor is operably coupled to the main shaft of the flaring device and is configured to rotate the main shaft.

According to the present aspect, the main shaft is driven by the motor, and an electric flaring tool having excellent usability is achieved.

### BRIEF DESCRIPTION OF THE DRAWINGS

FIG. 1 is a schematic view showing an overall configuration of a flaring tool according to a first embodiment.

FIG. 2 is an expanded partial view of FIG. 1, and is a cross-sectional view of a flaring device when a main shaft is at an initial position.

FIG. 3 is an expanded partial view of FIG. 2.

FIG. 4 is a left side view of a second sleeve, a movable flange, an adjustment flange, and a rotation stopper of a clutch mechanism.

FIG. 5 is a perspective view, as seen from the rear, of the second sleeve, the movable flange, the adjustment flange, and the rotation stopper of the clutch mechanism.

FIG. 6 is a cross-sectional view along a line VI-VI shown in FIG. 3.

FIG. 7 is a cross-sectional view corresponding to FIG. 6, and shows the rotation stopper in contact with a protrusion.

FIG. 8 is a cross-sectional view of the flaring device when the main shaft is at a forward movement obstructed position, and the movable flange is at a connected position.

FIG. 9 is a cross-sectional view of the flaring device when the main shaft is at the forward movement obstructed position, and the movable flange is at a disconnected position.

FIG. 10 is a cross-sectional view showing an overall configuration of a flaring tool according to a second embodiment.

### DETAILED DESCRIPTION OF THE EMBODIMENTS

In a non-limiting embodiment of the present disclosure, a clutch mechanism may include a rotation stopper configured separately from a movable clutch member. The rotation stopper may be configured to (i) allow rotation of the movable clutch member in a first direction and (ii) restrict rotation of the movable clutch member in a second direction. According to this embodiment, a structure of each of the movable clutch member and the rotation stopper can be optimized.

In addition to, or as an alternative to the above-described embodiment, the stopper may be a member that is at least partially elastically deformable. The rotation stopper may be configured to (i) allow the rotation of the movable clutch member in a first direction by elastically deforming, and (ii) restrict the rotation of the movable clutch member in a second direction by being latched to be non-rotatable relative to the housing. According to this embodiment, it is possible to appropriately allow and restrict the rotation of the movable clutch member, using the elastic deformation of the rotation stopper.

In addition to, or as an alternative to the above-described embodiment, the rotation stopper may be configured to restrict the rotation of the movable clutch member in the second direction by being directly latched to the housing. According to this embodiment, an advantage is obtained in that there is no need to provide a structure for latching the rotation stopper separately from the housing. Note that the rotation stopper may be directly latched to the housing by abutting a protrusion provided on an inner surface of the housing, for example.

In addition to, or as an alternative to the above-described embodiment, the rotation stopper may be a flat plate-shaped spring member. According to this embodiment, it is possible to minimize a dimension of the rotation stopper in a first axial direction.

In addition to, or as an alternative to the above-described embodiment, the rotation stopper may include at least one arm portion extending in a circumferential direction around a first axis. The at least one arm portion may be configured to (i) allow the rotation of the movable clutch member in the first direction by bending, and (ii) restrict the rotation of the movable clutch member in the second direction by a leading end of the at least one arm portion being directly latched to the housing. According to this embodiment, it is possible to appropriately allow and restrict the rotation of the movable clutch member, using the elastic deformation of the at least one arm portion.

In addition to, or as an alternative to the above-described embodiment, the at least one arm portion may include a plurality of arm portions arranged at equal intervals in the circumferential direction. According to this embodiment, it is possible to more reliably restrict the rotation of the movable clutch member in the second direction, using the arm portions arranged in a balanced manner in the circumferential direction.

In addition to, or as an alternative to the above-described embodiment, the flaring device may further include a thrust bearing that is disposed between the movable clutch member and a pressing spring in a front-rear direction. A part of the rotation stopper may be disposed between the thrust bearing and the movable clutch member. According to this embodiment, thrust bearing can separate the pressing spring from the rotation of the rotation stopper and the movable clutch member.

In addition to, or as an alternative to the above-described embodiment, the device may be configured as an attachment that is selectively attachable to an electric tool that is configured to rotationally drive a final output shaft. According to this embodiment, a user can attach the flaring device to the electric tool (a drilling tool, a tightening tool, for example) that is configured to rotationally drive a final output shaft only when necessary, and use the attached flaring device. It is thus possible to increase the operations that can be applied to the electric tool, and convenience is improved.

Hereinafter, representative and non-limiting embodiments of the present disclosure will be described in detail with reference to the drawings.

### First Embodiment

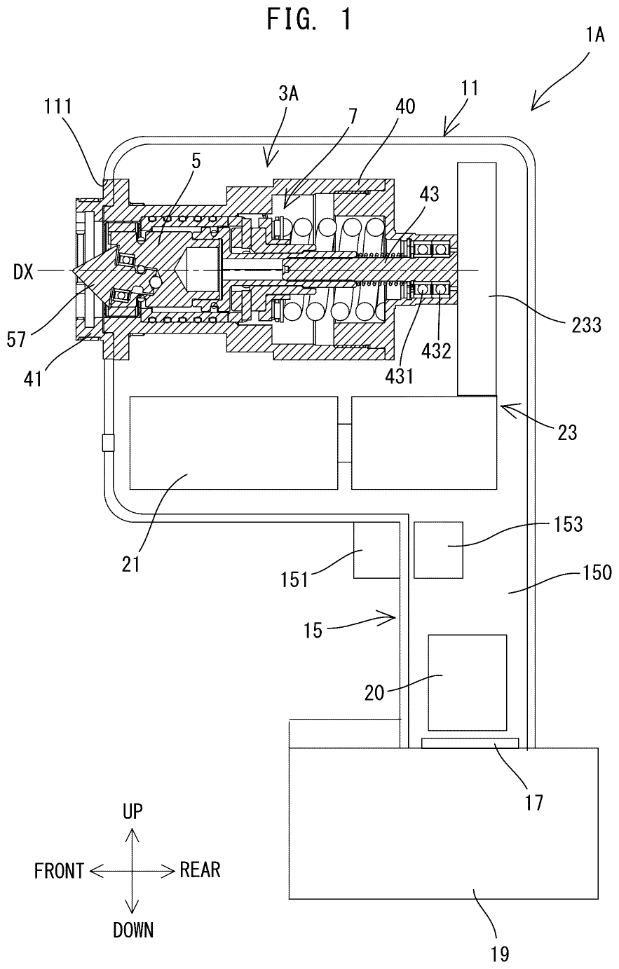

Hereinafter, a flaring tool 1A according to a first embodiment of the present disclosure will be described with reference to FIG. 1 to FIG. 9. The flaring tool 1A is an electric tool that, in order to enable accurate coupling of metal (generally copper) pipes (tubes) for refrigerant, is used to expand an end portion of the pipe into a cone shape.

First, an overall configuration of the flaring tool 1A will be described.

As shown in FIG. 1, the outer shape of the flaring tool 1A is formed by a tool housing 11 and a handle portion 15.

The tool housing 11 extends along a drive axis DX of a flaring device 3A. The tool housing 11 houses an electric motor 21, a speed reduction mechanism 23 operably coupled to the motor 21, and the flaring device 3A operably coupled to the speed reduction mechanism 23. An opening 111 is formed at one end of the tool housing 11. A clamp attachment portion 41, which is a tip end portion of the flaring device 3A, protrudes to the outside of the opening 111. Although not shown in detail herein due to being known technology, a clamp device of a pipe can be attached to the clamp attachment portion 41.

The handle portion 15 protrudes from the tool housing 11 in a direction intersecting (specifically, a direction substantially orthogonal to) the drive axis DX in a cantilever manner. The handle portion 15 includes a grip portion 150 configured to be gripped by a user. The grip portion 150 extends in a direction intersecting the drive axis DX, and includes a trigger 151 configured to be pressed by the user. A switch 153 and a controller 20 are housed inside the handle portion 15. The switch 153 is normally OFF, and is configured to be turned ON in response to the pressing of the trigger 151. The controller 20 is a control device configured to control operations of the flaring tool 1A.

A battery attachment portion 17 is provided at an end portion that is closer to a free end of the handle portion 15. The flaring tool 1A is operated by power supplied from a battery 19 removably mounted to the battery attachment portion 17. Note that the flaring tool 1A may be configured to be operated by power supplied from an external AC power supply via an electrical cord.

The clamp device clamping the pipe is first attached to the clamp attachment portion 41 of the flaring device 3A. When the user presses the trigger 151, the switch 151 is turned ON, and the controller 20 drives the motor 21. The flaring device 3A is driven, via the speed reduction mechanism 23, by the driving of the motor 21, and a flare (a portion expanded into a cone shape) is formed in the end portion of the pipe. Note that, hereinafter, the operation to form the flare will sometimes simply be referred to as a flaring operation.

The detailed configuration of the flaring tool 1A will be described below. Note that, hereinafter, for convenience of description, the extending direction of the drive axis DX is defined as a front-rear direction of the flaring tool 1A. In the front-rear direction, the side at which the tip end portion (the clamp attachment portion 41) of the flaring device 3A is located is defined as a front side, and the opposite side is defined as a rear side. A direction that is orthogonal to the drive axis DX and that corresponds to a longitudinal direction of the grip portion 150 is defined as an up-down direction of the flaring tool 1A. In the up-down direction, the side at which the free end of the handle portion 15 is located is defined as a lower side, and the opposite side is defined as an upper side. A direction that is orthogonal to the front-rear direction and the up-down direction is defined as a left-right direction of the flaring tool 1A.

The configuration of the tool housing 11 and the handle portion 15 will be described.

As shown in FIG. 1, in the present embodiment, the tool housing 11 is formed integrally with the handle portion 15. More specifically, two halves (a left-side shell and a right-side shell) including each of portions respectively forming the tool housing 11 and the handle portion 15 are coupled and fixed together in the left-right direction, thus forming the integrated housing. However, the tool housing 11 and the handle portion 15 may be formed separately and coupled and fixed to each other.

Hereinafter, components (structure) disposed inside the tool housing 11 and the handle portion 15 will be described.

As shown in FIG. 1, the motor 21 is housed in a lower portion of a front half of the tool housing 11. A rotational axis of an output shaft (not shown in the drawings) of the motor 21 extends in parallel to the drive axis DX, below the drive axis DX. The motor 21 is electrically connected to the controller 20, and is controlled by the controller 20.

The speed reduction mechanism 23 is housed in a rear half of the lower portion of the tool housing 11, to the rear of the motor 21. The speed reduction mechanism 23 is operably coupled to the output shaft (not shown in the drawings) of the motor 21, and to a main shaft 5 of the flaring device 3A to be described later. The speed reduction mechanism 23 is configured to decelerate a rotation speed of the output shaft of the motor 21 and output the decelerated rotation to the flaring device 3A. Although not shown in detail, the speed reduction mechanism 23 according to the present embodiment is a gear speed reduction mechanism including a plurality of gears. An output gear 233 of the speed reduction mechanism 23 is operably coupled to the flaring device 3A.

The flaring device 3A is disposed above the motor 21 inside the tool housing 11. The flaring device 3A will be described below.

The controller 20 is disposed inside the lower portion of the handle portion 15, below the switch 153 housed in the upper portion of the handle portion 15. The controller 20 includes at least one processor (a CPU, for example) or a processing circuit, and is electrically connected to the motor 21 and the switch 153. In the present embodiment, the controller 20 rotates the motor 21 in a forward direction during a period in which the switch 153 is turned ON by the trigger 151 being pressed. The controller 20 stops the rotation of the motor 21 when the pressing of the trigger 151 is released and the switch 153 is turned OFF, and further, rotates the motor 21 in a reverse direction.

Hereinafter, the flaring device 3A will be described in detail.

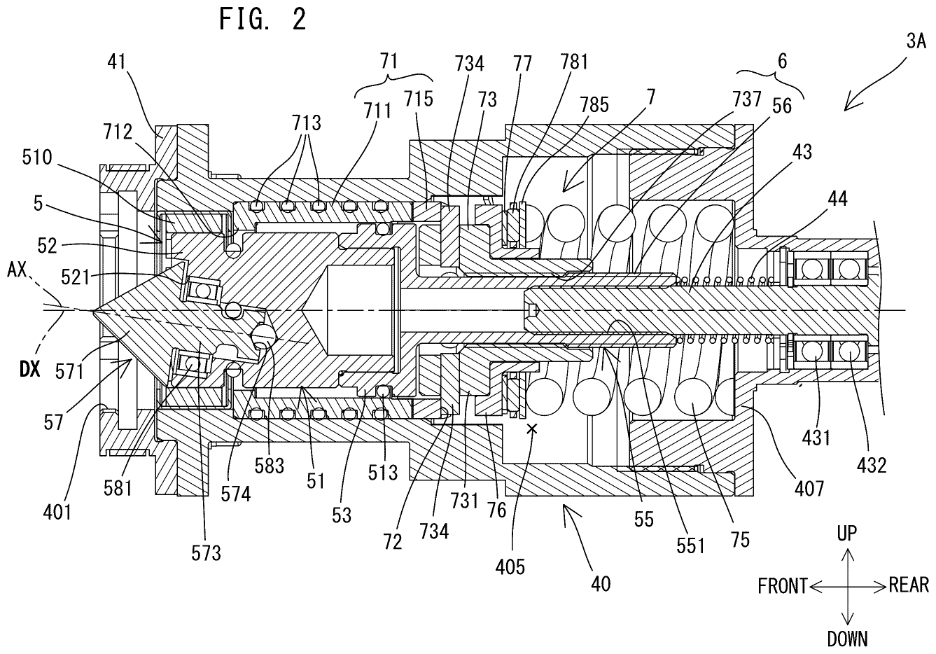

As shown in FIGS. 1 and 2, the flaring device 3A includes a housing 40, a transmission shaft 43, the main shaft 5, a cone 57, and a clutch mechanism 7. The transmission shaft 43, the main shaft 5, the cone 57, and the clutch mechanism 7 are housed in the housing 40. Note that the flaring device 3A according to the present embodiment is configured as a single assembly in which these components are coupled together.

As a whole, the housing 40 is an elongate stepped tubular-shaped member. The housing 40 is disposed so as to extend in the front-rear direction along the drive axis DX. Although not shown in detail, the housing 40 is appropriately positioned and held at the position inside the tool housing 11 by the tool housing 11. Note that, when the tool housing 11 is formed by the two halves divided to the left and right, as with the present embodiment, the housing 40 (the flaring device 3A as the assembly) may be held while being sandwiched between the left and right halves. Note also that it can be said that the tool housing 11 is an outer housing of the flaring tool 1A, and that the housing 40 is an inner housing of the flaring tool 1A, or a drive mechanism housing.

The front end portion of the housing 40 protrudes forward of the tool housing 11 through the opening 111 of the tool housing 11. The front end portion of the housing 40 is configured as the clamp attachment portion 41. Note that it is sufficient that the clamp attachment portion 41 be configured to removably hold any known desired clamp device (not shown in the drawings) of a pipe. Therefore, a holding structure for holding the clamp device is not particularly limited and any known structure may be adopted.

The transmission shaft 43 is operably coupled to the output gear 233 of the speed reduction mechanism 23. The transmission shaft 43 is configured to transmit the rotation of the output gear 233 to the main shaft 5. More specifically, the transmission shaft 43 is supported by two bearings 431 and 432 disposed inside the rear end portion of the housing 40 so as to be rotatable around the drive axis DX. Although not shown in detail, the rear end portion of the transmission shaft 43 is coupled to the output gear 233 so as to be coaxial with the output gear 233. The transmission shaft 43 rotates integrally with the output gear 233 in accordance with the driving of the motor 21.

As shown in FIG. 2, the main shaft 5 is an elongate member defining the drive axis DX, and is also referred to as a spindle. The main shaft 5 extends in the front-rear direction inside the housing 40. As will be described in detail later, the main shaft 5 can move in the front-rear direction along the drive axis DX while rotating around the drive axis DX. A front end portion 52 of the main shaft 5 rotatably supports the cone 57 for forming the flare. The cone 57 protrudes forward from an opening 401 in the front end of the housing 40 (the clamp attachment portion 41), in accordance with the forward movement of the main shaft 5.

The main shaft 5 includes a cylindrically-shaped slide portion 51, and a shaft portion 55 extending to the rear from the rear end of the slide portion 51.

The slide portion 51 forms the front half of the main shaft 5. The front end portion of the slide portion 51, namely, the front end portion 52 of the main shaft 5, rotatably supports the cone 57 for forming the flare. The front end portion 52 is supported to be rotatable around the drive axis DX and to be slidable in the front-rear direction, by a bearing 510 disposed inside a portion, of the housing 40, immediately to the rear of the clamp attachment portion 41. A rear end portion 53 of the slide portion 51 is a portion having a larger diameter than the rest of the slide portion 51. In other words, the rear end portion 53 is configured as a flange portion. As will be described in more detail later, the rear end portion 53 can slide along an inner surface of a fixed sleeve 71 (more specifically, a first sleeve 711) disposed inside the housing 40.

The shaft portion 55 has a smaller diameter than the slide portion 51, extends rearward from a center portion of the slide portion 51, and forms the rear end portion of the main shaft 5. The shaft portion 55 has a hollow shaft shape, and includes a coupling hole 551 having a polygonal shape (a hexagonal shape, for example) in a cross section thereof. The front end portion of the transmission shaft 43 is formed in a shape corresponding to the coupling hole 551, and is inserted into the coupling hole 551. According to this type of configuration, the main shaft 5 can rotate integrally with the transmission shaft 43, and can slide in the front-rear direction relative to the transmission shaft 43. Note that the coupling structure of the main shaft 5 and the transmission shaft 43 is not limited to this example. For example, the main shaft 5 and the transmission shaft 43 may be coupled to each other through engagement between a key groove and a key, or a spline connection, such that the main shaft 5 can rotate integrally with the transmission shaft 43 and can move in the front-rear direction relative to the transmission shaft 43.

The rear end portion of the shaft portion 55 (that is, the rear end portion of the main shaft 5) is formed as a male screw portion 56. As will be described in detail later, the male screw portion 56 can be screwed together with a female screw portion 737 of a movable flange 73 of the clutch mechanism 7.

As shown in FIG. 2, the cone 57 includes a conical shaped conical portion 571, and a solid cylindrical shaft portion 573. The shaft portion 573 extends rearward coaxially with the conical portion 571, from a center portion of a circular rear end surface of the conical portion 571. A ball holding hole 574 is formed in a rear end of the shaft portion 573. A bottom portion of the ball holding hole 574 is a conical hole.

The cone 57 is supported by the front end portion 52 of the main shaft 5 so as to be rotatable around an axis AX that is different from the axis of the main shaft 5 (i.e., different from the drive axis DX). In other words, the cone 57 is supported eccentrically to the main shaft 5. More specifically, a support hole 521 is formed in the front end portion 52. The support hole 521 extends along the axis AX and is configured to receive the shaft portion 573 of the cone 57. In the present embodiment, the axis AX is inclined at a predetermined angle with respect to the drive axis DX. However, in another embodiment, the axis AX may be parallel to the drive axis DX. The support hole 521 is a stepped bottomed hole that is open at a front end surface of the front end portion 52. The support hole 521 includes a large diameter portion at the open side, a small diameter portion at the bottom side, and a bottom portion. Each of the large diameter portion and the small diameter portion of the support hole 521 has a substantially constant diameter. On the other hand, the bottom portion of the support hole 521 is a conical hole in which the diameter becomes smaller the further to the rear.

A bearing 581 is fitted in the large diameter portion of the support hole 521. The bearing 581 is a radial bearing that is configured to receive a radial load. A front half of the shaft portion 573 of the cone 57 is fitted into the bearing 581, and is supported to be rotatable around the axis AX. Note that, in the present embodiment, the cone 57 is disposed such that the apex thereof is normally positioned on the drive axis DX. By positioning the apex portion of the cone 57 on the drive axis DX in this way, it is possible to form a flare in an end portion of a thinner pipe, compared to when the apex of the cone 57 is offset from the drive axis DX.

Of the shaft portion 573, a section extending further to the rear than the bearing 581 is disposed inside the small diameter portion of the support hole 521. A ball 583 is disposed in the conical hole of the ball holding hole 574 of the shaft portion 573 of the cone 57, and in the conical hole of the support hole 521. According to this type of configuration, the ball 583 can function as a thrust bearing that receives a thrust load, and can also function as a radial bearing that receives a radial load.

The clutch mechanism 7 will be described below.

As shown in FIG. 2, the clutch mechanism 7 includes the fixed sleeve 71, the movable flange 73, a pressing spring 75, and a rotation stopper 77.

The fixed sleeve 71 is fitted into the front half of the housing 40, to the rear of the bearing 510, and is held so as to be substantially unmovable relative to the housing 40. Note that the fixed sleeve 71 according to the present embodiment is a single hollow cylindrical body formed by coupling the first sleeve 711 and a second sleeve 715 to each other in the front-rear direction.

The first sleeve 711 occupies a major portion of the fixed sleeve 71. The outer diameter of the first sleeve 711 is substantially constant, and is slightly smaller than the inner diameter of the housing 40. A flange portion 712, which protrudes radially inward of the first sleeve 71, is provided at a front end portion of the first sleeve 711. Although not shown in detail, the flange portion 712 functions as a stopper defining a frontmost position of the main shaft 5, when the main shaft 5 has been moved forward in a state in which the pipe is not attached to the flaring tool 1A. More specifically, the flange portion 712 comes into contact with the front end of the rear end portion 53 (the flange portion) of the slide portion 51 of the main shaft 5, and obstructs the main shaft 5 from moving any further forward. Of the first sleeve 711, the inner diameter of the remaining portion other than the flange portion 712 is substantially constant.

In the radial direction of the main shaft 5 (a direction orthogonal to the drive axis DX), a plurality of seal members 713 are disposed between the first sleeve 711 and the housing 40. The seal members 713 block (close off, seal) a gap between the first sleeve 711 and the housing 40. More specifically, the seal members 713 are each a ring-shaped elastic member (a so-called O ring), and are respectively mounted to ring-shaped grooves formed in the outer peripheral surface of the first sleeve 711. A squeeze of each of the seal members 713 is set such that the first sleeve 711 is held to be substantially unmovable relative to the housing 40. Note that, here, “substantially unmovable” covers a case in which a slight displacement due to the elastic deformation of the seal members 713 is allowed.

When foreign material (metal waste or dust, for example) has entered an interior space of the housing 40 via the opening 401, the seal members 713 can prevent the foreign material from entering into a space 405 to the rear of the seal members 713 via the gap between the housing 40 and the first sleeve 711. As will be described in more detail later, a feed screw mechanism 6, which moves the main shaft 5 in the front-rear direction, and the clutch mechanism 7 are disposed in the space 405 to the rear of the seal members 713. Thus, a lubricant is present inside the space 405. As well as preventing the foreign material from entering into the space 405 and reducing a possibility of an operation failure of the feed screw mechanism 6 and the clutch mechanism 7, the seal members 713 can prevent the lubricant (grease, for example) from leaking out to the front from the space 405.

As described above, the rear end portion 53 of the slide portion 51 of the main shaft 5 is disposed so as to be slidable inside the first sleeve 711. In the radial direction of the main shaft 5, a seal member 513 is disposed between the rear end portion 53 of the slide portion 51 and the first sleeve 711. The seal member 513 is a ring-shaped elastic member (a so-called O ring), and is mounted to a ring-shaped groove formed in the outer peripheral surface of the rear end portion 53 of the slide portion 51. A squeeze of the seal member 513 is set such that the rear end portion 53 of the slide portion 51 can slide along the inner surface of the first sleeve 711.

In a similar manner to the above-described seal members 713, when foreign material has entered the interior space of the housing 40 via the opening 401, the seal member 513 can prevent the foreign material from entering to the rear of the seal member 513 via a gap between the slide portion 51 and the first sleeve 711. Thus, in a similar manner to the seal members 713, the seal member 513 can prevent the foreign material from entering into the space 405 and can prevent the lubricant from leaking out from the space 405.

The second sleeve 715 is a cylinder shape that is shorter than the first sleeve 711, and has substantially the same inner diameter and outer diameter as those of the first sleeve 711. The second sleeve 715 is coupled to the rear end of the first sleeve 711 so as to be non-rotatable relative to the first sleeve 711.

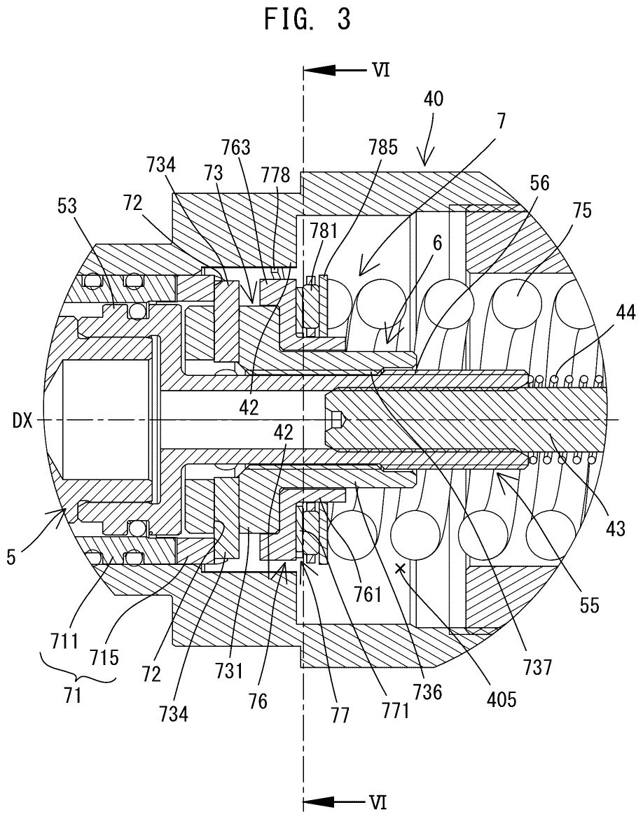

As shown in FIGS. 3 to 5, the second sleeve 715 includes a cam surface 72. The cam surface 72 is provided along an entire circumference of the second sleeve 715 at a rear end of the second sleeve 715 (i.e., the rear end of the fixed sleeve 71), and includes recesses 721 and protrusions 723 arranged alternately in a circumferential direction of the second sleeve 715. In the present embodiment, four of the recesses 721 are arranged at equal intervals in the circumferential direction.

Note that, taking weight reduction into account, the first sleeve 711 according to the present embodiment is made of aluminum. On the other hand, since the cam surface 72 receives a high load, the second sleeve 715 is made of iron in order to secure sufficient strength. Thus, the second sleeve 715 is formed as a separate (discrete, independent) member from the first sleeve 711, which is made of aluminum in order to achieve weight reduction, and is coupled to the first sleeve 711. However, in another embodiment, the fixed sleeve 71 may be formed as a single (inseparable) member using the same material as a whole.

The movable flange 73 is a flanged hollow cylindrical member (flange sleeve). The movable flange 73 is disposed around the shaft portion 55 of the main shaft 5, to the rear of the fixed sleeve 71 (more specifically, to the rear of the second sleeve 715). The movable flange 73 includes a large diameter portion 731 (also referred to as a flange portion) to which four clutch pins 734 are fixed, and a small diameter portion 736. The small diameter portion 736 has a smaller outer diameter than the large diameter portion 731, and extends rearward from the large diameter portion 731. The movable flange 73 and the clutch pins 734 according to the present embodiment are made of iron.

The large diameter portion 731 has an inner diameter larger than that of the shaft portion 55 of the main shaft 5, and an outer diameter slightly smaller than the inner diameter of the fixed sleeve 71 (the second sleeve 715). The clutch pins 734 are arranged at equal intervals in the circumferential direction of the large diameter portion 731, and extend radially. The number of the clutch pins 734 and the positions thereof in the circumferential direction correspond to the number of the recesses 721 of the cam surface 72 and the positions thereof in the circumferential direction. A part of each of the clutch pins 734 protrudes radially outward of the large diameter portion 731, and is normally in contact with the cam surface 72 of the second sleeve 715. A front end portion of the large diameter portion 731 is disposed inside the second sleeve 715 of the fixed sleeve 71.

A portion of the small diameter portion 736 other than the rear end portion is configured as the female screw portion 737 that is threadably engageable with the male screw portion 56 of the main shaft 5. The male screw portion 56 of the main shaft 5 and the female screw portion 737 of the movable flange 73 form the feed screw mechanism 6 that is configured to move the main shaft 5 and the movable flange 73 relative to each other in the front-rear direction. The male screw portion 56 corresponds to a screw shaft of the feed screw mechanism 6, and the female screw portion 737 corresponds to a nut. Note that the feed screw mechanism 6 may be configured as a ball screw mechanism. In this case, a plurality of balls are rollably disposed in a track defined by a spiral groove formed in the outer peripheral surface of the main shaft 5 and a spiral groove formed in the inner peripheral surface of the movable flange 73, and the main shaft 5 and the movable flange 73 are engaged with each other via the balls.

In the present embodiment, an adjustment flange 76 is fixed to the movable flange 73. The adjustment flange 76 includes a small diameter portion 761 fixed around the small diameter portion 736 of the movable flange 73, and a flange-shaped large diameter portion 763 protruding radially outward from a front end of the small diameter portion 761. The outer diameter of the large diameter portion 763 is larger than that of the large diameter portion 731 of the movable flange 73. A circular ring-shaped recess is formed in a front end surface of the large diameter portion 763, and a rear end portion of the large diameter portion 731 of the movable flange 73 is fixed in a state of being fitted into this recess.

Note that the adjustment flange 76 is provided in order to appropriately transfer the load of the pressing spring 75 to the movable flange 73, and the outer diameter of the large diameter portion 763 is roughly the same as the diameter of the pressing spring 75. The adjustment flange 76 may be configured as a single member integrated with the movable flange 73, or may be omitted as appropriate depending on the dimensions of the large diameter portion 763 of the movable flange 73 and of the pressing spring 75.

As shown in FIG. 2, an auxiliary spring 44 is disposed between a rear end of the main shaft 5 and a washer disposed to the front of the bearing 431 inside the rear end portion of the housing 40. The auxiliary spring 44 according to the present embodiment is a compression coil spring and is disposed around the transmission shaft 43. The auxiliary spring 44 urges (biases) the main shaft 5 forward relative to the housing 40. The auxiliary spring 44 is configured such that the auxiliary spring 44 holds the male screw portion 508 at a position at which the male screw portion 508 can engage the female screw portion 737 when the main shaft 5 moves rearward and the male screw portion 508 is disengaged from the female screw portion 737. The urging force (biasing force, load) of the auxiliary spring 44 is set to be significantly weaker than the pressing spring 75 to be described below.

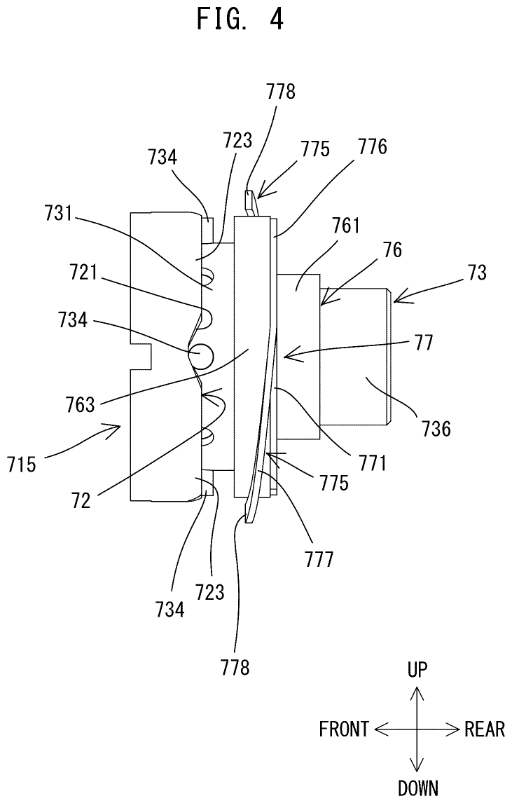

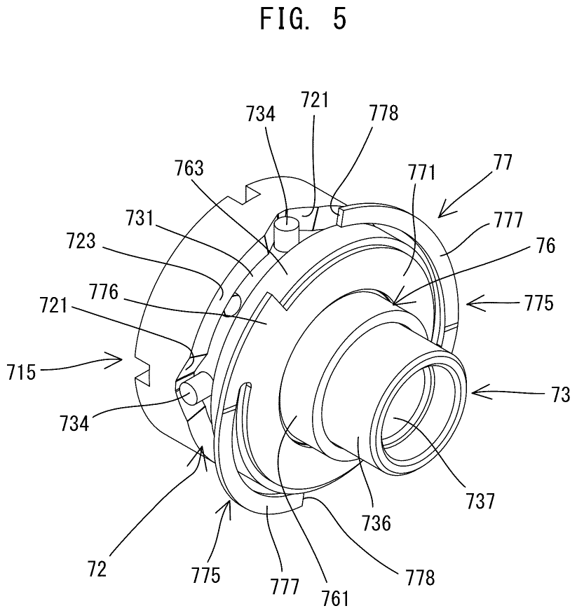

As shown in FIGS. 2 and 3, the pressing spring 75 is configured to urge (bias) the movable flange 73 forward relative to the fixed sleeve 71. The pressing spring 75 according to the present embodiment is a compression coil spring and is disposed around the small diameter portion 736 of the movable flange 73 (and the small diameter portion 761 of the adjustment flange 76), to the rear of the large diameter portion 731 of the movable flange 73. Normally, the pressing spring 75 urges (biases) the movable flange 73 forward and presses the clutch pins 734 against the cam surface 72 of the second sleeve 715. The clutch pins 734 are thus held inside the recesses 721 of the cam surface 72 (refer to FIGS. 4 and 5). In this way, the movable flange 73 is integrated with the fixed sleeve 71 so as to be substantially non-rotatable relative to the fixed sleeve 71. Hereinafter, the position of the movable flange 73 relative to the fixed sleeve 71 in the front-rear direction at this time will be referred to as a connected position.

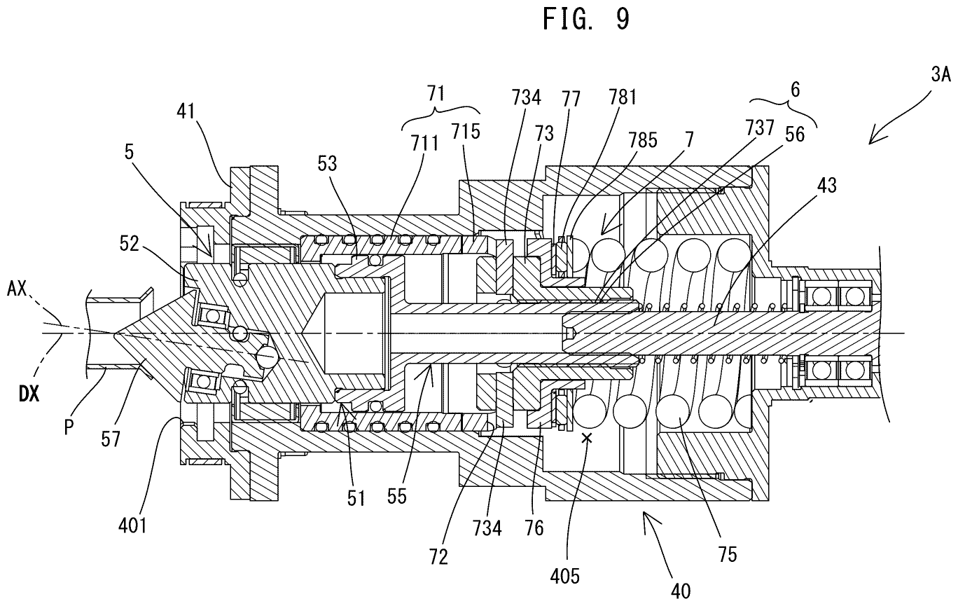

As will be described in more detail later, the movable flange 73 can move rearward from the connected position relative to the fixed sleeve 71, to a position at which the clutch pins 734 are separated from the cam surface 72 (hereinafter referred to as a disconnected position, refer to FIG. 9). When the movable flange 73 is disposed at the disconnected position, the movable flange 73 can rotate together with the main shaft 5 relative to the fixed sleeve 71.

As shown in FIG. 3, in the present embodiment, in the front-rear direction, the large diameter portion 763 of the adjustment flange 76, a part of the rotation stopper 77 (more specifically, a base portion 771 to be described later), a thrust bearing 781, and a washer 785 are interposed, in that order from the front side, between the large diameter portion 731 of the movable flange 73 and the front end of the pressing spring 75. Note that, in the present embodiment, as the thrust bearing 781, a thrust needle bearing is employed in which a plurality of needles are simply rotatably held by a holder, and the base portion 771 of the rotation stopper 77 and the washer 785 function as a bearing ring. A rear end of the pressing spring 75 is in contact with a shoulder portion 407 of the housing 40 (refer to FIG. 2). A front end of the pressing spring 75 is in contact with the washer 785. Thus, the pressing spring 75 urges (biases) the movable flange 73 forward via the above-described interposed members.

The rotation stopper 77 is configured to allow the movable flange 73 to rotate freely in one direction around the drive axis DX and to restrict the rotation in the opposite direction.

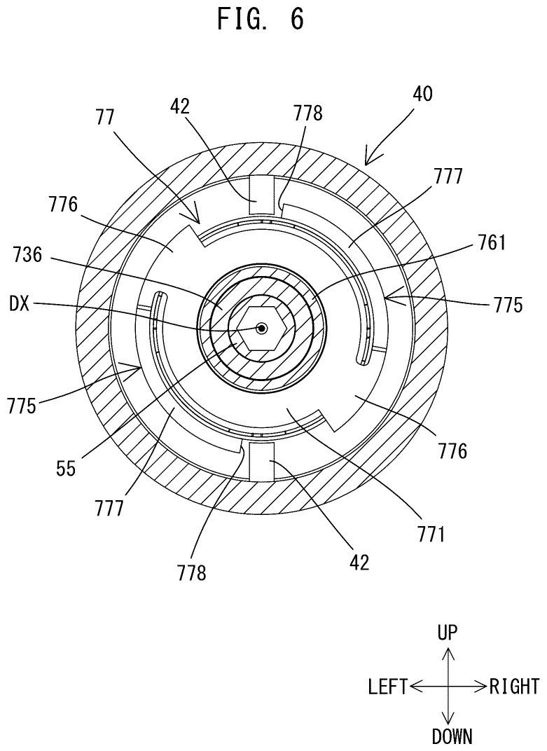

The rotation stopper 77 according to the present embodiment is configured as a flat plate-shaped spring member that can elastically deform. More specifically, as shown in FIGS. 5 and 6, the rotation stopper 77 includes the base portion 771, and two arm portions 775 that extend from the base portion 771. The base portion 771 and the arm portions 775 are integrally formed by machining a single metal plate.

The base portion 771 is a flat plate portion having a circular ring shape. When seen from the rear of the rotation stopper 77, the two arm portions 775 are disposed to be symmetrical with respect to the center of the base portion 771. More specifically, the two arm portions 775 are connected to the base portion 771 at positions symmetrical to each other on either side of the center of the base portion 771. Each of the arm portions 775 includes a base end portion 776 protruding radially outward from the outer edge of the base portion 771, and an extension portion 777 extending in an arc shape from the base end portion 776 to one side around the drive axis DX. More specifically, when seen from the rear, the extension portion 777 extends in the counterclockwise direction from the base end portion 776.

As shown in FIGS. 3 to 6, the base portion 771 of the rotation stopper 77 is disposed around the small diameter portion 761 of the adjustment flange 76. A front surface of the base portion 771 is in contact with a rear surface of the large diameter portion 763 of the adjustment flange 76, and a rear surface of the base portion 771 is in contact with the thrust bearing 781 (more specifically, with the needles thereof). The base portion 771 is pressed against the large diameter portion 763 by the urging force (biasing force, load) of the pressing spring 75, and in this way, the rotation stopper 77 rotates integrally with the adjustment flange 76 and the movable flange 73 around the drive axis DX. On the other hand, the pressing spring 75 is separated from the rotation of these members by the thrust bearing 781.

The base end portion 776 of the arm portion 775 is at substantially the same position as the base portion 771 in the front-rear direction. On the other hand, radially outward of the large diameter portion 763 of the adjustment flange 76, the extension portion 777 of the arm portion 775 extends forward from the base end portion 776 toward a leading end 778 that is a free end. The extension portion 777 can bend in the front-rear direction.

On the other hand, as seen in FIGS. 3 and 6, two protrusions 42 are provided inside the housing 40 that are configured to come into contact with the rotation stopper 77, and thus restrict the rotation of the rotation stopper 77 to one side relative to the housing 40.

More specifically, the two protrusions 42 protrude radially inward (toward the drive axis DX) from the inner surface of the cylindrical housing 40, at positions facing each other on either side of the drive axis DX. Leading ends of the protrusions 42 are positioned more radially inward than outer edges of the extension portions 777 of the arm portions 775. The position and length of each of the protrusions 42 in the front-rear direction are set such that, regardless of the position of the movable flange 73 in the front-rear direction relative to the housing 40, (i) the base end portion 776 of the arm portion 775 of the rotation stopper 77 is positioned further to the rear than the rear end of the protrusion 42, and (ii) the leading end 778 of the extension portion 777 of the arm portion 775 is positioned between the front end and the rear end of the protrusion 42.

As a result of the configuration of the rotation stopper 77 and the protrusions 42 described above, regardless of the position of the movable flange 73 in the front-rear direction relative to the housing 40, when the rotation stopper 77 rotates in the clockwise direction as seen from the rear, the extension portions 777 of the arm portions 775 come into contact with the rear ends of the protrusions 42 and bend rearward, and can pass over the protrusions 42. Specifically, when seen from the rear, the rotation of the rotation stopper 77, the adjustment flange 76, and the movable flange 73 in the clockwise direction relative to the housing 40 and the fixed sleeve 71 is allowed.

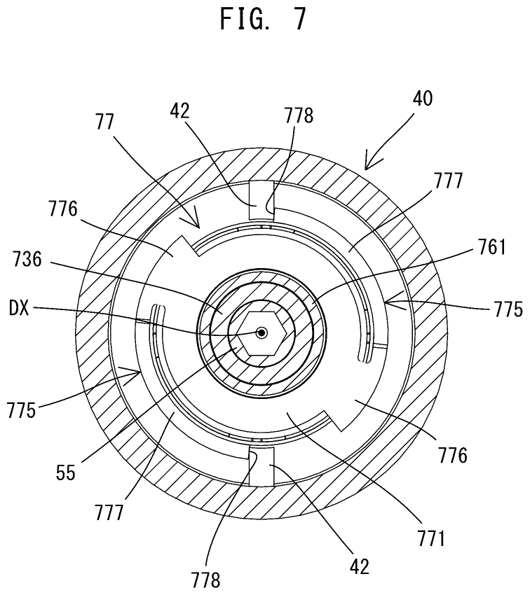

On the other hand, when the rotation stopper 77 rotates in the counterclockwise direction when seen from the rear, as shown in FIG. 7, when the leading ends 778 of the extension portions 777 of the arm portions 775 come into contact with side surfaces of the protrusions 42, the rotation of the rotation stopper 77 further in the counterclockwise direction is obstructed by the protrusions 42. Specifically, when seen from the rear, the rotation of the rotation stopper 77, the adjustment flange 76, and the movable flange 73 in the counterclockwise direction relative to the housing 40 and the fixed sleeve 71 is restricted.

Operations of the flaring device 3A when the motor 21 is driven will be described below.

As shown in FIG. 2, in an initial state of the flaring device 3A, the male screw portion 56 of the rear end portion of the main shaft 5 is disposed at a position at which the male screw portion 56 is threadedly engageable with the female screw portion 737 of the movable flange 73 (hereinafter referred to as an initial position). At this time, the movable flange 73 is at the connected position, and is substantially unmovable relative to the fixed sleeve 71 and the housing 40. The controller 20 (refer to FIG. 1) starts to rotate the motor 21 in the forward direction in response to the switch 153 being turned ON. When the motor 21 is rotated in the forward direction, the main shaft 5 rotates in the clockwise direction around the drive axis DX when seen from the rear. In accordance with the main shaft 5 rotating in the clockwise direction, when seen from the rear, the main shaft 5 is fed forward by the feed screw mechanism 6. Hereinafter, the rotation in the clockwise direction when seen from the rear will also be referred to as a forward rotation/rotating in the forward direction, and the rotation in the counterclockwise direction when seen from the rear will also be referred to as a reverse rotation/rotating in the reverse direction.

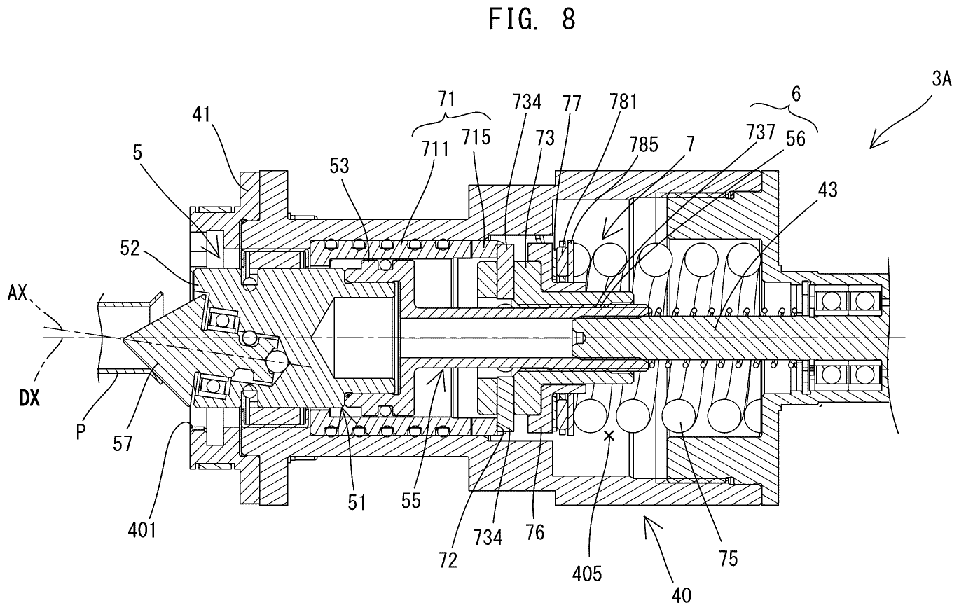

As shown in FIG. 8, when a pipe P is clamped by the clamp device (not shown in the drawings) attached to the clamp attachment portion 41, as the main shaft 5 continues to rotate in the forward direction, the cone 57 comes into contact with an end portion of the pipe P before the main shaft 5 reaches a frontmost position. The cone 57 expands the end portion of the pipe P into a conical shape, by orbiting (revolving) around the drive axis DX while rotating (freely rotating) around the axis AX, as a result of the main shaft 5 rotating while moving forward. When the cone 57 moves forward to a certain extent while expanding the end portion of the pipe P into the conical shape and forming the flare, the forward movement of the cone 57 and thus, the forward movement of the main shaft 5, is obstructed by the pipe P held in the clamp device, before the main shaft 5 reaches the frontmost position. FIG. 8 shows a position of the main shaft 5 at this time (hereinafter referred to as a forward-movement obstructed position).

When the main shaft 5 continues to rotate in the forward direction at the forward-movement obstructed position, due to the action of the feed screw mechanism 6, the movable flange 73 moves rearward relative to the fixed sleeve 71, in resistance to the urging force (biasing force) of the pressing spring 75. In this way, as shown in FIG. 9, the clutch pins 734 separate from the cam surface 72, and the movable flange 73 moves to the disconnected position at which the rotation relative to the fixed sleeve 71 is possible. Hereinafter, the movement of the movable flange 73 from the connected position to the disconnected position will also be referred to as actuation of the clutch mechanism 7. Note that, at a time point at which the main shaft 5 can no longer move forward, the shape of the flare is already formed. Therefore, it may be said that the clutch mechanism 7 is actuated in response to the forming of the flare.

The pressing spring 75 is compressed in accordance with the rearward movement of the movable flange 73, and the urging force (biasing force) of the pressing spring 75 increases. The feed screw mechanism 6 is configured such that a frictional force between the male screw portion 56 and the female screw portion 737 exceeds the urging force (biasing force) of the pressing spring 75 at this time. Thus, when the movable flange 73 reaches the disconnected position, the movable flange 73 does not move any further, and starts to rotate in the forward direction integrally with the main shaft 5 that is at the forward-movement obstructed position. As described above, the extension portions 777 (refer to FIG. 6) of the arm portions 775 can pass over the protrusions 42 of the housing 40 while bending in the front-rear direction, and thus the rotation stopper 77 rotates integrally with the movable flange 73 in the forward direction.

The urging force (biasing force) of the pressing spring 75 acts on the main shaft 5 via the movable flange 73. The cone 57 supported by the front end portion 52 of the main shaft 5 receives the urging force, and rotates around the axis AX while orbiting around the drive axis DX, while pressing the flare at substantially the same position in the front-rear direction. Hereinafter, this operation of the cone 57 will also be referred to as a finishing operation.

As described above, in the present embodiment, after the controller 20 has stopped the motor 21 in response to the switch 153 being turned OFF by the user releasing the trigger 151, the controller 20 rotates the motor 21 in the reverse direction. When the motor 21 is rotated in the reverse direction while the movable flange 73 is at the disconnected position, the main shaft 5 is rotated in the reverse direction. At this time, when the urging force (biasing force, load) from the pressing spring 75 acting on the movable flange 73 exceeds a reaction force (load) acting on the main shaft 5 from the pipe P, the main shaft 5 is moved rearward by the feed screw mechanism 6, in response to the reverse rotation of the main shaft 5. The movable flange 73 is moved forward by the urging force (biasing force) of the pressing spring 75, and returns to the connected position.

On the other hand, when the main shaft 5 starts to rotate in the reverse direction, the urging force (biasing force) of the pressing spring 75 and the reaction force from the pipe P may cancel each other out. In this case, the movable flange 73 starts to rotate in the reverse direction integrally with the main shaft 5 at the disconnected position. However, as shown in FIG. 7, when the leading ends 778 of the arm portions 775 of the rotation stopper 77 come into contact with the protrusions 42 of the housing 40, the continuing reverse rotation of the rotation stopper 77 and the movable flange 73 is obstructed, and the rearward movement of the main shaft 5 by the feed screw mechanism 6 is started. In this way, since the reaction force from the pipe P is reduced, the movable flange 73 is moved forward by the urging force (biasing force) of the pressing spring 75, and returns to the connected position.

When the reverse rotation of the main shaft 5 is continued, the main shaft 5 moves rearward while rotating in the reverse direction until the male screw portion 56 is disengaged from the female screw portion 737, and the main shaft 5 returns to the initial position shown in FIG. 2. The controller 20 stops the rotation of the motor 21 in the reverse direction in accordance with the main shaft 5 returning to the initial position. Note that the controller 20 may stop the motor 21 based on a detection result of a detection device (not shown in the drawings) that can detect when the main shaft 5 is at the initial position, for example. This detection device is, for example, a non-contact sensor (a magnetic or an optical position sensor, or a proximity sensor, for example), or may be a mechanical contact switch (a microswitch, for example).

As described above, in the flaring device 3A according to the present embodiment, the fixed sleeve 71 having the cam surface 72, and the movable flange 73 that is pressed against the cam surface 72 by the pressing spring 75 are employed as the clutch mechanism 7. Thus, it is possible to simplify the configuration of the clutch mechanism 7, compared to a known clutch mechanism in which clutch pins and an urging spring that urges the clutch pins toward a clutch flange that is on a movable side are held at an opening in a side portion of a holder. Since there is no need to provide an opening in a side portion of the housing 40 housing the clutch mechanism 7, it is possible to reduce the possibility of the lubricant leaking out from the housing 40.

As described above, as a result of restricting the reverse rotation of the movable flange 73, it is possible to inhibit the movable flange 73 and the main shaft 5 from continuing to rotate integrally in the reverse direction, and to reliably return the main shaft 5 to the initial position. In the present embodiment, since the reverse rotation of the movable flange 73 is restricted using the rotation stopper 77 that is provided separately from the movable flange 73, it is possible to optimize the structure of each of the movable flange 73 and the rotation stopper 77. Since the rotation stopper 77 is the single plate-shaped spring member, there is an advantage in that manufacturing costs can be suppressed, and also in that a thickness of the rotation stopper 77 in the direction of the drive axis DX can be minimized.

### Second Embodiment

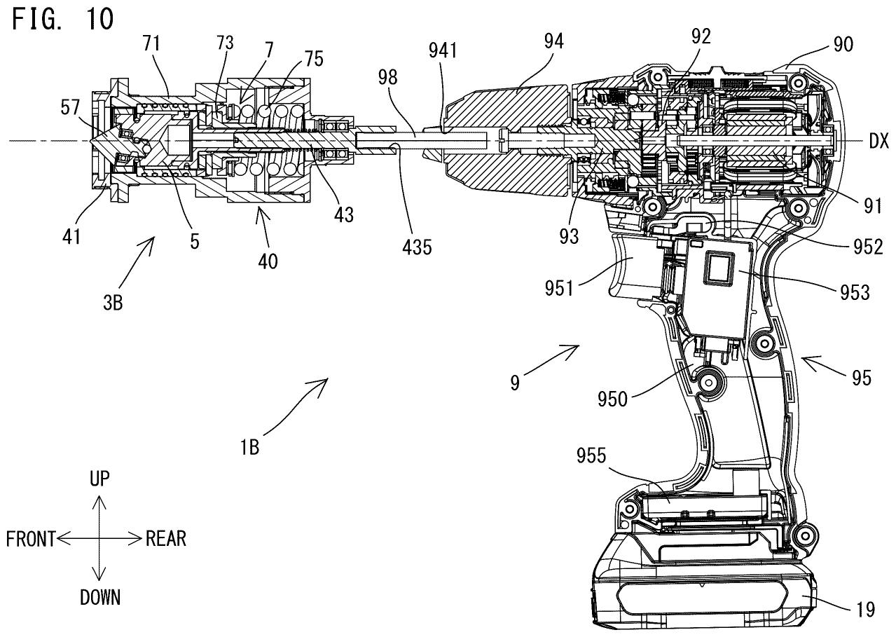

A flaring tool 1B according to a second embodiment of the present disclosure will be described below with reference to FIG. 10. The flaring tool 1A (refer to FIG. 1) according to the first embodiment is the electric tool used exclusively for the flaring operation, and the flaring device 3A is built into the tool housing 11 along with the motor 21 and the like. In contrast to this, the flaring tool 1B according to the second embodiment includes an existing drill driver 9, and a flaring device 3B removably attached to the drill driver 9. In other words, the flaring device 3B is an attachment that can be attached to the drill driver 9.

The drill driver 9 is a known electric tool (rotating tool) configured to rotationally drive a tool accessory (not shown in the drawings), which is removably attached to a chuck 94, to rotate around the drive axis DX. The drill driver 9 includes a tool housing 90 that extends along the drive axis DX, and a handle portion 95 that extends from the tool housing 90 in a direction intersecting the drive axis DX.

A motor 91, and a spindle 93 operably coupled to the motor 91 via a speed reduction mechanism 92 are housed in the tool housing 90. The chuck 94 is coupled to the spindle 93 so as to rotate integrally with the spindle 93.

The handle portion 95 includes a grip portion 950. A trigger 951 that is configured to be pressed by the user, and a forward/reverse switching lever 952 that moves in response to the pressing operation by the user and switches the rotation direction of the motor 91 between the forward direction and the reverse direction are disposed at the grip portion 950. A switch 953 that operates in response to the manual operation of the trigger 951 and the forward/reverse switching lever 952, and a controller 955 that controls the driving of the motor 91 are housed in the interior of the handle portion 95. While the trigger 951 is pressed and the switch 953 is turned ON, the controller 955 rotates the motor 91 in the rotation direction specified by the forward/reverse switching lever 952. The rechargeable battery 19 is removably attached to the lower end portion of the handle portion 95.

The main configuration of the flaring device 3B is substantially the same as that of the flaring device 3A according to the first embodiment. Thus, in the following description, the same reference signs as those of the first embodiment are allocated to the configuration that is substantially the same, and a description thereof is omitted.

The flaring device 3B according to the present embodiment is configured such that the main shaft 5 is operably coupled to the spindle 93 of the drill driver 9, and is rotated in accordance with the rotational driving of the spindle 93. More specifically, a coupling hole 435 is formed in a rear end portion of the transmission shaft 43 of the flaring device 3B. The coupling hole 435 is configured to be coupled to another member so as to be able to transmit the rotation thereof, and extends along the axes of the transmission shaft 43 and the main shaft 5.

The transmission shaft 43 is operably coupled to the chuck 94 of the drill driver 9, via a coupling shaft 98. One axial end portion of the coupling shaft 98 is engageable with the coupling hole 435 of the transmission shaft 43. The other axial end portion of the coupling shaft 98 is engageable with an insertion hole 941 for the tool accessory formed in the chuck 94 of the drill driver 9. Note that the coupling hole 435, the insertion hole 941, and the two axial end portions of the coupling shaft 98 may have a polygonal shape in a cross section thereof, in a similar manner to the coupling hole 551 of the main shaft 5 and the front half of the transmission shaft 43 according to the first embodiment, for example. For example, the coupling shaft 98 may be coupled integrally and rotatably with the chuck 94 and the transmission shaft 43, through engagement between a key groove and a key, or a spline connection.

The rotation of the spindle 93 of the drill driver 9 is transmitted to the transmission shaft 43 via the chuck 94 and the coupling shaft 98. Thus, when the motor 91 of the drill driver 9 is rotated in the forward direction, as described in the first embodiment, the main shaft 5 of the flaring device 3B moves forward, and the cone 57 forms the flare in the end portion of the pipe. When the motor 91 of the drill driver 9 is rotated in the reverse direction, the main shaft 5 moves rearward, and returns to the initial position.

As described above, the flaring device 3B according to the present embodiment is configured to be selectively attached to the drill driver 9, as the attachment that can execute the flaring operation. Thus, the user can attach the flaring device 3B to the drill driver 9 only when necessary, and can use the attached flaring device 3B as a flaring tool 1B. It is thus possible to increase the operations that can be applied to the drill driver 9, and convenience is improved.

Note that the flaring device 3B may be selectively attached to and used on not only the drill driver 9, but another rotating tool (a drilling tool, a tightening tool, for example) via an appropriate coupling shaft. The flaring device 3B may be selectively attached to and used with not the electric tool, but a manual tool provided with a coupling shaft that can be manually rotated and thus configure a manual flaring device integrated with the manual tool.

A correspondence relationship between each of the structural elements (features) of the above-described embodiments and each of the structural elements (features) of the present disclosure or the present invention will be indicated below. However, each of the structural elements of the embodiments is merely an example and does not limit each of the structural elements of the present disclosure or present invention.

Each of the flaring device 3A according to the first embodiment and the flaring device 3B according to the second embodiment is an example of a “flaring device”. The drive axis DX is an example of a “first axis”. The axis AX is an example of a “second axis”. The fixed sleeve 71 (more specifically, the second sleeve 715) is an example of a “fixed clutch member”. The integrated movable flange 73 and the clutch pins 734 are an example of a “movable clutch member”. The connected position and the disconnected position of the movable flange 73 are, respectively, examples of a “first position” and a “second position”. The drill driver 9 according to the second embodiment is an example of an “electric tool”. The spindle 93 is an example of a “final output shaft”. The flaring tool 1A according to the first embodiment is an example of a “flaring tool”.

Note that the flaring device according to the present disclosure is not limited to the flaring devices 3A and 3B according to the above-described embodiments. For example, changes exemplified below in a non-limiting manner are possible. At least one of these changes can be adopted in combination with at least one of the flaring devices 3A and 3B according to the embodiments, and the features disclosed in the claims.

For example, the configuration of the fixed sleeve 71 of the clutch mechanism 7 and/or of the movable flange 73 can be changed as appropriate. For example, in place of the clutch pins 734, the movable flange 73 may include integrally provided protrusions at a front end surface of the large diameter portion 731, and these protrusions may directly engage with the recesses 721 of the cam surface 72, without the clutch pins 734 being interposed therebetween. The shape, number, and positions of the recesses 721 and the protrusions 723 of the cam surface 72, and the shape, number, and positions of the corresponding clutch pins 734 (or protrusions) can be changed as appropriate.

The configuration that allows the free forward rotation of the movable flange 73 while restricting the reverse rotation is not limited to the rotation stopper 77. For example, the number and/or positions of the arm portions 775 of the rotation stopper 77 may be changed from the example of the above-described embodiments. In the case of the plurality of arm portions 775, the arm portions 775 are preferably arranged at equal intervals. Note that this also applies to the protrusions 42 of the housing 40. The protrusions 42 need not necessarily be provided on the housing 40, and may be disposed inside the housing 40, and provided on members integrally formed with the housing 40. The rotation stopper 77 and the protrusions 42 may be changed such that the arm portions 775 bend radially inward when the rotation stopper 77 allows the rotation of the movable flange 73.

In place of the rotation stopper 77 provided separately from the movable flange 73, the movable flange 73 itself may be provided with a configuration in which the forward rotation of the movable flange 73 is allowed while the reverse rotation is restricted. For example, a spring member equivalent to the arm portions 775 of the rotation stopper 77 according to the above-described embodiments may be fixed to the adjustment flange 76 or the movable flange 73.

Furthermore, in place of the rotation stopper 77, a one way clutch may be employed that is disposed between the movable flange 73 and the housing 40 (or a member integrated with the housing 40). In this modified example, it is sufficient that the one way clutch be configured to (i) allow the free rotation of the movable flange 73 relative to the housing 40 when the movable flange 73 is rotating in the forward direction by causing the movable flange 73 to idle at this time, and (ii) suppress the rotation of the movable flange 73 relative to the housing 40 when the movable flange 73 is rotating in the reverse direction, by causing the movable flange 73 to integrally rotate with the housing 40 at this time.

In the first embodiment, the controller 20 performs the control to change the rotation direction of, and start and stop the driving of the motor 21 (and thus of the main shaft 5) based only on the switch 153 being turned ON and OFF. However, for example, the controller 20 may perform the control to change the rotation direction of, and start and stop the driving of the motor 21 in accordance with the operation of a forward/reverse switch, the position of the main shaft 5 identified using a detection device, the actuation of the clutch mechanism detected using a detection device, and the like.

In view of the gist of the present invention and of the above-described embodiments, the following aspects are constructed. At least one of the following aspects can be adopted in combination with at least one of the features of the above-described embodiments and modified examples thereof, or with at least one of the features disclosed in each of the claims herein.

### Aspect 1

The cam surface includes at least one recess and at least one protrusion arranged alternately in a circumferential direction of the fixed clutch member, and when the movable clutch member is at the first position, the movable clutch member is configured to engage with the at least one recess of the cam surface.

### Aspect 2

At least one protrusion is provided in the interior of the housing, and the protrusion is configured to inhibit the rotation stopper from rotating in the second direction by abutting the rotation stopper.

### Aspect 3

The rotation stopper includes a flat plate-shaped base portion disposed around the periphery of the movable clutch member, between the movable clutch member and the thrust bearing, and
the at least one arm portion includes a base end portion protruding radially outward from the base portion, and an extension portion extending in the circumferential direction from the base end portion, radially outward of the movable clutch member.

### Aspect 4

The rotation stopper is pressed against the movable clutch member by an urging force of the pressing spring, and rotates integrally with the movable clutch member.

### DESCRIPTION OF THE REFERENCE NUMERALS

1A, 1B: Flaring tool, 11: Tool housing, 111: Opening, 15: Handle portion, 150: Grip portion, 151: Trigger, 153: Switch, 17: Battery attachment portion, 19: Battery, 20: Controller, 21: Motor, 23: Speed reduction mechanism, 233: Output gear, 3A, 3B: Flaring device 40: Housing, 401: Opening, 405: Space, 407: Shoulder portion, 41: Clamp attachment portion, 42: Protrusion, 43: Transmission shaft, 431: Bearing, 432: Bearing, 435: Coupling hole 44: Auxiliary spring 5: Main shaft, 51: Slide portion, 510: Bearing, 513: Seal member, 52: Front end portion, 521: Support hole, 53: Rear end portion, 55: Shaft portion, 551: Coupling hole, 56: Male screw portion, 57: Cone, 571: Conical portion, 573: Shaft portion, 574: Ball holding hole, 581: Bearing, 583: Ball, 6: Feed screw mechanism, 7: Clutch mechanism, 71: Fixed sleeve, 711: First sleeve, 712: Flange portion, 713: Seal member, 715: Second sleeve, 72: Cam surface, 721: Recess, 723: Protrusion, 73: Movable flange, 731: Large diameter portion, 734: Clutch pin, 736: Small diameter portion, 737: Female screw portion, 75: Pressing spring, 76: Adjustment flange, 761: Small diameter portion, 763: Large diameter portion, 77: Rotation stopper, 771: Base portion, 775: Arm portion, 776: Base end portion, 777: Extension portion, 778: Leading end, 781: Thrust bearing, 785: Washer, 9: Drill driver, 90: Tool housing, 91: Motor, 92: Speed reduction mechanism, 93: Spindle, 94: Chuck, 95: Handle portion, 98: Coupling shaft, 941: Insertion hole, 950: Grip portion, 951: Trigger, 952: Forward/reverse switching lever, 953: Switch, 955: Controller, AX: Axis, DX: Drive axis, P: Pipe.

1. A flaring device comprising:
a housing;
a main shaft that is rotatable around a first axis defining a front-rear direction of the flaring device, the main shaft being (i) housed in the housing to be movable in the front-rear direction along the first axis, and (ii) including a first engagement portion;
a cone that is (i) eccentrically supported at a front end portion of the main shaft to be rotatable around a second axis that is different from the first axis, and (ii) configured to form a flare in an end portion of a pipe; and
a clutch mechanism that is housed in the housing, wherein
the clutch mechanism includes
a fixed clutch member including a cam surface, the fixed clutch member being disposed around the main shaft to be substantially unmovable relative to the housing,
a movable clutch member that is disposed around the main shaft to the rear of the fixed clutch member, the movable clutch member including a second engagement portion that is configured to directly or indirectly engage with the first engagement portion of the main shaft, and
a pressing spring that is configured to urge the movable clutch member in a forward direction,
the first engagement portion of the main shaft and the second engagement portion of the movable clutch member form a feed screw mechanism that is configured to move the main shaft and the movable clutch member relative to each other in the front-rear direction,
the movable clutch member is movable in the front-rear direction relative to the fixed clutch member, between (i) a first position where the movable clutch member is pressed against the cam surface by an urging force of the pressing spring and is held to be substantially non-rotatable relative to the fixed clutch member, and (ii) a second position where the movable clutch member separates from the cam surface and is rotatable relative to the fixed clutch member, and
at the second position, the movable clutch member is configured to (i) be freely rotatable, relative to the fixed clutch member, in a first direction that is a rotation direction when the main shaft is moved in the forward direction, and (ii) be restricted from rotating in a second direction that is a rotation direction when the main shaft is moved in a rearward direction.

2. The flaring device according to claim 1, wherein
the clutch mechanism includes a rotation stopper that is formed separately from the movable clutch member, and
the rotation stopper is configured to (i) allow the rotation of the movable clutch member in the first direction, and (ii) restrict the rotation of the movable clutch member in the second direction.

3. The flaring device according to claim 2, wherein
the rotation stopper is a member that is at least partially elastically deformable, and
the rotation stopper is configured to (i) allow the rotation of the movable clutch member in the first direction by elastically deforming, and (ii) restrict the rotation of the movable clutch member in the second direction by being latched to be non-rotatable relative to the housing.

4. The flaring device according to claim 3, wherein
the rotation stopper is configured to restrict the rotation of the movable clutch member in the second direction by being directly latched to the housing.

5. The flaring device according to claim 4, wherein
at least one protrusion is provided in an interior of the housing, and
the protrusion is configured to inhibit the rotation stopper from rotating in the second direction by abutting the rotation stopper.

6. The flaring device according to claim 3, wherein
the rotation stopper is a flat plate-shaped spring member.

7. The flaring device according to claim 6, wherein
the rotation stopper includes at least one arm portion extending in a circumferential direction of the first axis, and
the at least one arm portion is configured to (i) allow the rotation of the movable clutch member in the first direction by bending, and (ii) restrict the rotation of the movable clutch member in the second direction by a leading end of the at least one arm portion being directly latched to the housing.

8. The flaring device according to claim 7, further comprising:
a thrust bearing that is disposed between the movable clutch member and the pressing spring in the front-rear direction, wherein
a part of the rotation stopper is disposed between the thrust bearing and the movable clutch member,
the rotation stopper includes a flat plate-shaped base portion disposed around the movable clutch member, between the movable clutch member and the thrust bearing, and
the at least one arm portion includes
a base end portion protruding radially outward from the base portion, and
an extension portion extending in the circumferential direction from the base end portion, radially outward of the movable clutch member.

9. The flaring device according to claim 7, wherein
the at least one arm portion includes a plurality of arm portions arranged at equal intervals in the circumferential direction.

10. The flaring device according to claim 9, wherein
the rotation stopper is configured to restrict the rotation of the movable clutch member in the second direction by being directly latched to the housing,
a plurality of protrusions are provided in an interior of the housing,
the plurality of protrusions are configured to inhibit the rotation stopper from rotating in the second direction by abutting the rotation stopper, and
a number of the plurality of protrusions provided in the interior of the housing corresponds to a number of the plurality of arm portions arranged at equal intervals in the circumferential direction.

11. The flaring device according to claim 2, further comprising:
a thrust bearing that is disposed between the movable clutch member and the pressing spring in the front-rear direction, wherein
a part of the rotation stopper is disposed between the thrust bearing and the movable clutch member.

12. The flaring device according to claim 2, wherein
the rotation stopper is pressed against the movable clutch member by the urging force of the pressing spring, and rotates integrally with the movable clutch member.

13. The flaring device according to claim 1, wherein
the flaring device is configured as an attachment that is selectively attachable to an electric tool that is configured to rotationally drive a final output shaft.

14. The flaring device according to claim 1, wherein
the cam surface includes at least one recess and at least one protrusion arranged alternately in a circumferential direction of the fixed clutch member, and
when the movable clutch member is at the first position, the movable clutch member is configured to engage with the at least one recess of the cam surface.

15. An electric flaring tool comprising:
a tool housing;
a flaring device that is housed in the tool housing; and
a motor that is (i) housed in the tool housing, (ii) operably coupled to a main shaft of the flaring device, and (iii) configured to rotate the main shaft, wherein
the flare forming device includes
a housing;
the main shaft that is configured to be rotatable around a first axis defining a front-rear direction of the flaring device, the main shaft being (i) housed in the housing to be movable in the front-rear direction along the first axis, and (ii) including a first engagement portion,
a cone that is (i) eccentrically supported at a front end portion of the main shaft to be rotatable around a second axis that is different from the first axis, and (ii) configured to form a flare in an end portion of a pipe; and
a clutch mechanism that is housed in the housing,
the clutch mechanism includes
a fixed clutch member that (i) includes a cam surface, and (ii) is disposed around the main shaft to be substantially unmovable relative to the housing,
a movable clutch member that is (i) disposed around the main shaft, to the rear of the fixed clutch member, and (ii) includes a second engagement portion configured to directly or indirectly engage with the first engagement member of the main shaft, and
a pressing spring that is configured to urge the movable clutch member in a forward direction,
the first engagement portion of the main shaft and the second engagement portion of the movable clutch member form a feed screw mechanism that is configured to move the main shaft and the movable clutch member relative to each other in the front-rear direction,
the movable clutch member is movable in the front-rear direction relative to the fixed clutch member, between (i) a first position where the movable clutch member is pressed against the cam surface by an urging force of the pressing spring and is held to be substantially non-rotatable relative to the fixed clutch member, and (ii) a second position where the movable clutch member separates from the cam surface and is rotatable relative to the fixed clutch member, and
at the second position, the movable clutch member is configured to (i) be freely rotatable, relative to the fixed clutch member, in a first direction that is a rotation direction when the main shaft is moved in the forward direction, and (ii) be restricted from rotating in a second direction that is a rotation direction when the main shaft is moved in a rearward direction.
